(19) United States
(12) Patent Application Publication
(10) Pub. No.: US 2017/0262316 A1
(43) Pub. Date: Sep. 14, 2017

(54) ALLOCATION OF RESOURCES

(71) Applicant: BULL SAS, Les Clayes-Sous-Bois (FR)

(72) Inventors: Jean-Vincent FICET, La Chapelle Blanche (FR); Sébastien DUGUE, Saint-Theoffrey (FR); Jean-Olivier GERPHAGNON, Vif (FR)

(21) Appl. No.: 15/510,541

(22) PCT Filed: Aug. 17, 2015
(86) PCT No.: PCT/FR2015/052212

§ 371 Date: Mar. 10, 2017

(30) Foreign Application Priority Data
Sep. 12, 2014 (FR) 1458596

(51) Int. Cl. G06F 9/50

(52) U.S. Cl. CPC G06F 9/5055; G06F 9/5083; H04L 67/10

(57) ABSTRACT

A method for allocating, in order to carry out a calculation, at least one first resource of a plurality of interconnected resources, the first resource being connected to a first port of a switch, the method including acquiring a first weight of the first resource, the weight corresponding to the number of resources of the plurality of resources connected to the first port of the switch.

### TECHNICAL FIELD OF THE INVENTION

The invention relates to the management of allocations of resources in a computer of the HPC or high performance computing type.

### PRIOR ART

In a high performance computer, computations are generally implemented on data processing systems called clusters. A cluster comprises a set of interconnected computing nodes. The connection between the nodes is achieved using Ethernet or Infiniband communication links (Ethernet and Infiniband are trademarks). These interconnection networks are generally connected in a multi-stage pyramidal architecture (also known as a CLOS network). When the packets are routed, they can pass through several switches and spread out the number of routes per link. The allocation of resources from one computing node to another, when a computation is started, by the resource manager takes place in a known manner according to different criteria which may be:
physical information linked to the computing nodes to use (number of processors on the equipment, size of the memory, etc.);
location information in the interconnection network (the nearest nodes in the topology, the nearest input/output nodes, etc.);
logical information relative to the nodes to use such as for example the presence of a given software on the local storage of the node or through a particular network mounting;
environmental information such as for example the maximum, or mean, consumption, of the nodes to use (for example as a function of the type of processor used), of the temperature of the area where the nodes to be used are located, etc.;
a combination of the preceding criteria.

A network is either non-blocking or blocking. If the network is blocking, this signifies that the number of routes per physical link may be different from one place of the interconnection topology to another. If the network is non-blocking, this signifies that there exists one route per physical link and in this case all the routes are the same as each other and all the equipment can make the most of the interconnection network. The blocking factor may also appear on an initially non-blocking configuration for example during the loss of an interconnection equipment. A non-blocking configuration for a network is the most interesting from the point of view of the rapidity and reactivity of said network but its implementation is extremely expensive and thus difficult to achieve financially because it would come down to having a dedicated link per pair of nodes. Thus most existing clusters are blocking.

However the information according to which a network is blocking or not, and thus the number of routes per link, is not taken into account at the level of the allocation is of resources by the resource manager.

### DESCRIPTION OF THE INVENTION

The invention aims to overcome all or part of the drawbacks of the prior art identified above, and in particular to propose a method making it possible to manage the blocking or non-blocking character of the network for the allocation of resources.

To this end, one aspect of the invention relates to a method for allocating, in order to carry out a first computation, at least one first resource of a plurality of resources, said first resource being connected to a first port of a switch, said method comprising a step of acquiring a first weighting of said first resource, said first weighting corresponding to the number of resources of the plurality of resources connected to the first port of the switch.

The resources are connected to each other and to the switches by means of communication links. The resources are interconnected within a cluster, the cluster generally comprises a plurality of switches. Each resource is connected to at least one port of at least one switch of the cluster. The first weighting of the first resource may be acquired by searching in a database, for example a routing database. The weighting of a resource makes it possible to determine if the resource is a blocking or non-blocking node.

Apart from the main characteristics that have been mentioned in the preceding paragraph, the method according to the invention may have one or more additional characteristics among the following, considered individually or according to any technically possible combinations thereof:
the method comprises a step of comparing the first weighting of said first resource with a predetermined value. The predetermined value with which the first weighting is compared depends on the level of service chosen by the user in order to carry out a computation;
the method comprises a step of acquiring a second weighting of a second resource of said plurality of resources, when the first weighting is different to the predetermined value. When the first weighting of the first resource does not correspond to the predetermined value, a second resource is sounded out in order to acquire therefrom its second weighting and to compare it with the predetermined value. Everything depends, once again, on the level of service specified by the user. If in its level of service, it is considered that this resource allocation criterion is less important than other resource allocation criteria, then the first resource could all the same be chosen;
the method comprises a step of allocating the first resource in order to carry out the first computation when the first weighting is equal to the predetermined value;
the method comprises a prior step of updating the first weighting of said first resource. This step makes it possible to take account of the dynamic character of the first weighting, but also the weighting of each of the resources, this step being able to be carried out beforehand for the set of resources of the plurality of resources. In fact, the weighting of a resource varies over time as a function of the state of the network. Thus if certain resources, i.e. computing nodes, go down, a switch port sees its number of resources connected to this switch decrease. The interconnection links between switches also have their importance in so far as if such a link goes down, the routes will have to be spread out on the remaining links, which can introduce an imbalance in the number of routes per link. Thanks to this prior step, the dynamic variation of the state of the network and the number of routes per link is taken into account for the allocation of resources,

### BRIEF DESCRIPTION OF THE FIGURES

Other characteristics and advantages of the invention will become clear on reading the description that follows, with reference to the appended figures, which illustrate:

FIG. 1, a schematic view of an example of configuration of an interconnection network for carrying out a method according to an embodiment of the invention;

FIG. 2, a schematic view of the ports of a switch of the interconnection network of FIG. 1;

FIG. 3, a schematic view of the physical links within the interconnection network of FIG. 1;

FIG. 4 illustrates in a schematic manner an example of carrying out the steps of a method for allocating a first resource in order to carry out a computation according to an embodiment of the invention.

For greater clarity, identical or similar elements are marked by identical reference signs in all of the figures.

### DETAILED DESCRIPTION OF AN EMBODIMENT

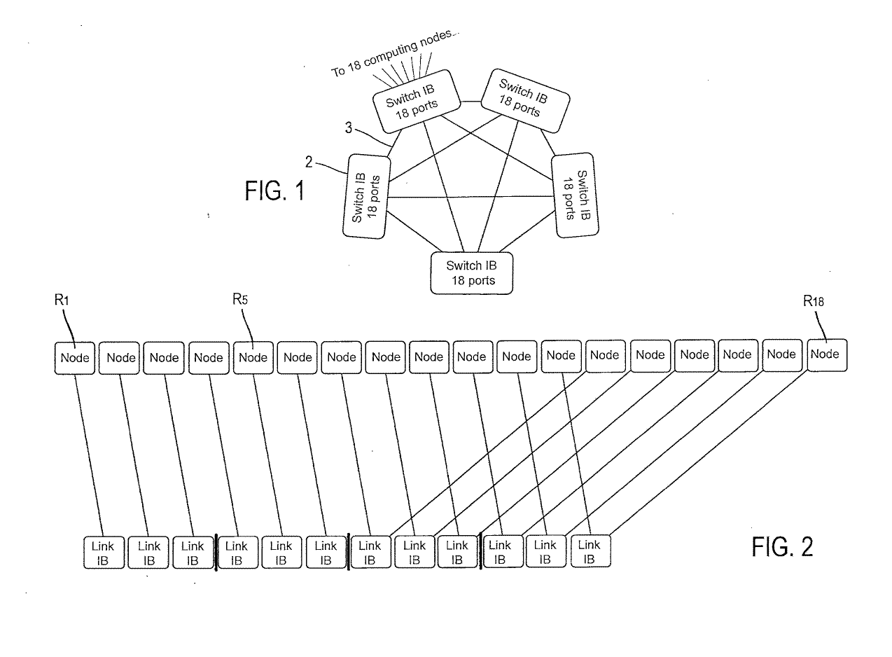

In FIG. 1 is illustrated an example of configuration of an interconnection network, in which the connection between the computing nodes Rn, i.e. the resources of a cluster, is realised using Infiniband communication links. The computing nodes are connected to each other by means of switches. These switches comprise connection ports.

In this example, the topology of the network is designated all-to-all. Five InfiniBand switches 2 (one of the types of interconnection network), each having 18 input and output ports, are each connected to 18 computing nodes.

Moreover, each of the InfiniBand switches is connected to each of the other switches by an InfiniBand link, i.e. in total four links come out of a switch.

In this configuration, it is chosen to connect each of the switches to each of the other switches of the topology by means of three links 3 (represented by a single line in FIG. 1). Thus, in total, twelve links come out of a switch in this topology to the other switches and eighteen come out to the eighteen computing nodes.

FIG. 2 illustrates the ports of an Infiniband switch of the topology of FIG. 1. This switch has in total 36 ports: 18 to the computing nodes (R₁ to R₁₈) and 18 intended for the other switches of the topology. Out of the 18 ports intended for the other switches of the topology, only 12 are used in this example of embodiment. A physical link is shared between two nodes, i.e. between a node intended for computing nodes and a node intended for the other switches of the topology, i.e. between an input node and an output node. It may be observed in FIG. 2 that in this configuration six links to the Infiniband switches are used in an exclusive manner by six computing nodes and twelve links to the Infiniband switches are used by twelve computing nodes in a shared manner. This configuration is defined by the routing algorithm which defines how the data packets pass from one switch to another, and thus which defines the links used to reach a destination from a source. It is thus observed that certain nodes are privileged and that others have to share their resources with at least one other node (there could be “worst” cases, with certain links in single use and other links shared with more than two nodes).

The information of the number of routes per physical link is an information available at the level of the routing manager of the interconnection infrastructure, that is to say that it is possible to know how many routes pass through a given physical link and also to which “nodes” these routes correspond. It is thus possible to know in a precise manner what are the “privileged” nodes (i.e. with the smallest number of routes per physical link) versus the less privileged nodes. This information is thus brought to the level of the resource manager in charge of allocating resources (in general computing nodes) according to given criteria,

The objective is thus to pass on this information of privilege level of a node as a function of the number of routes present on the links of the interconnection network making it possible to access it. This criterion may also be used to define “privileges” between computing nodes and certain components of the computer such as for example the part where the storage is located (inputs/outputs—E/S) and thus privilege the nodes which will have the least to share of the physical links to access the data.

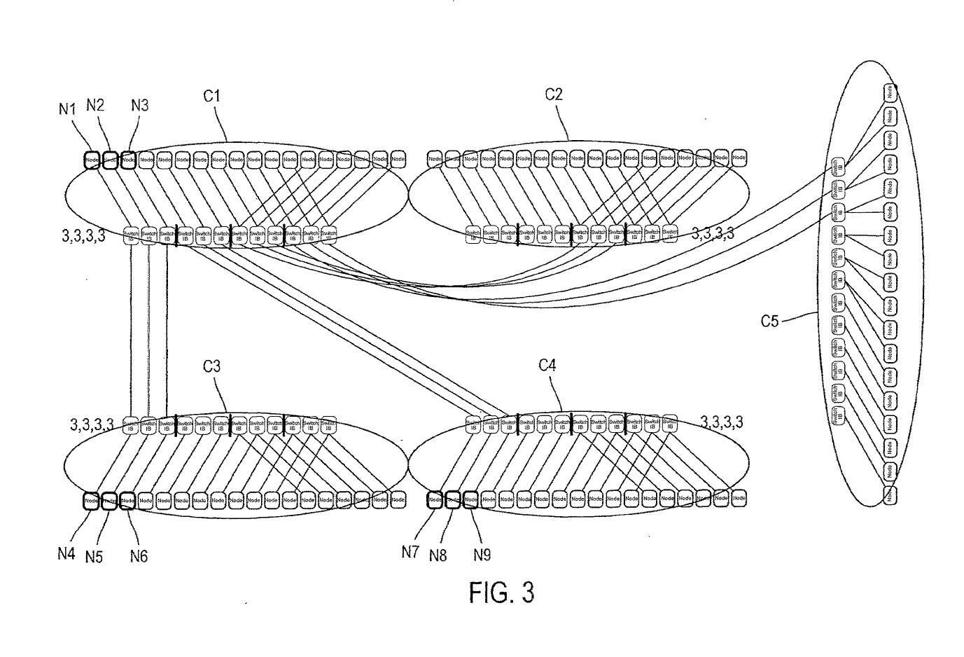

FIG. 3 illustrates an example of physical cabling of the interconnection network comprising the five Infiniband switches (C₁ to C₅) illustrated in FIG. 1. Each of the switches is connected to another switch of the network by means of three links going from a Link node Ib of a switch to a Link node Ib of another switch. In this configuration, nine nodes (N₁ to N₉) have a smaller number of routes per physical link compared to the other nodes of the topology. These nine nodes are thus assigned a weighting representative of this characteristic, for example a zero weighting, in order to indicate to the resource manager for the allocation of resources in order to carry out a computation that it would be advisable to privilege these nine nodes to launch a work.

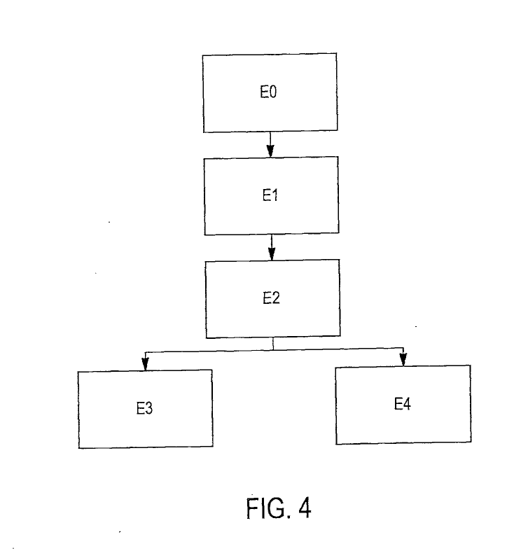

FIG. 4 illustrates in a schematic manner an example of carrying out the steps of a method for allocating a first resource in order to carry out a computation.

The method comprises a prior step E0 of updating the first weighting of the first resource. The first weighting corresponds to the number of resources connected to the first port of the switch to which is connected the first resource within an interconnection network. The updating takes place by rewriting for example in the routing table of the network which takes an inventory of the number of routes per physical link of the network once said network has been covered.

The method also comprises a step E1 that corresponds to the acquisition of the first weighting of the first resource. This step of acquisition can take place by reading within a routing database of the network. The method then comprises a step E2 of comparing the first weighting with a predetermined value which corresponds to the level of service for example.

Depending on the result of step E2 of comparing the first weighting with the predetermined value, the method comprises either:
a step E3 of allocating the first resource in order to carry out the first computation when the first weighting is equal to the predetermined value;
a step E4 of acquiring a second weighting of a second resource of said plurality of resources, when the first weighting is different to the predetermined value. This step E4 of acquiring the second weighting of a second resource aims to make it possible to cover if necessary the set of resources of the plurality of resources in order to find a resource having a weighting equal to the predetermined value.

The invention is not limited to the embodiments described previously with reference to the figures and variants could be envisaged without going beyond the scope of the invention.

1. A method for allocating, in order to carry out a computation, at least one first resource of a plurality of interconnected resources, said first resource being connected to a first port of a switch, said method comprising a acquiring a first weighting of said first resource, said first weighting corresponding to a number of resources of the plurality of resources connected to the first port of the switch,

2. The method according to claim 1, further comprising comparing the first weighting of said first resource with a predetermined value.

3. The method according to claim 2, further comprising acquiring a second weighting of a second resource of said plurality of resources, when the first weighting is different from the predetermined value.

4. The method according to claim 2, further comprising allocating the first resource in order to carry out the first computation when the first weighting is equal to the predetermined value.

5. The method according to claim 1, further comprising updating the first weighting of said first resource.
